(19) United States
(12) Patent Application Publication
(10) Pub. No.: US 2019/0129262 A1
(43) Pub. Date: May 2, 2019

(54) LIQUID CRYSTAL DISPLAY PANEL AND LIQUID CRYSTAL DISPLAY DEVICE

(71) Applicant: Wuhan China Star Optoelectronics Technology Co., Ltd., Wuhan, Hubei (CN)

(72) Inventors: Hualun YU, Wuhan, Hubei (CN); Anshi LI, Wuhan, Hubei (CN)

(21) Appl. No.: 15/580,612

(22) PCT Filed: Nov. 21, 2017
(86) PCT No.: PCT/CN2017/112183

§ 371 Date: Dec. 7, 2017

(30) Foreign Application Priority Data
Oct. 31, 2017 (CN) 201711045604.8

(51) Int. Cl. G02F 1/1362; G02F 1/1335; G02F 1/1368

(52) U.S. Cl. CPC G02F 1/136209; G02F 1/1368; G02F 1/133514

(57) ABSTRACT

A liquid crystal display panel and a liquid crystal display device having the liquid crystal display panel are provided. The liquid crystal display panel includes a TFT array substrate and a color filter substrate disposed opposite to each other. The color filter substrate has a black matrix disposed thereon, the black matrix includes a first portion located in a display area and a second portion located in an non-display area. The second portion of the black matrix is provided with a groove surrounding the display area, the groove penetrates the black matrix in a thickness direction of the black matrix. The TFT array substrate is provided with a light shielding layer corresponding to a location where the groove is disposed, and a projection of the light shielding layer on the black matrix completely covers the groove.

### RELATED APPLICATIONS

The present application is a National Phase of International Application Number PCT/CN2017/112183, filed Nov. 21, 2017, and claims the priority of China Application No. 201711045604.8, filed Oct. 31, 2017.

### FIELD OF THE DISCLOSURE

The disclosure relates to a display technical field, and more particularly to a liquid crystal display panel and a liquid crystal display device.

### BACKGROUND

Liquid crystal display device (LCD) is a flat and ultra-thin display device, which consists of a certain number of color or black and white pixels placed in front of a light source or a reflective surface. The power consumption of liquid crystal display device is very low, it has advantages of high image quality, small size, and light weight, and is much favored and becomes a mainstream in the monitor industry. A commonly used liquid crystal display panel includes at least a TFT array substrate and a color filter substrate disposed opposite to each other, and a liquid crystal layer between the TFT array substrate and the color filter substrate. The TFT array substrate and the color filter substrate are further attached with a lower polarizer and an upper polarizer, respectively.

As shown in FIG. 1, the color filter substrate generally includes a base substrate 1, a black matrix (BM) 2 and color photoresists R, G and B formed on the base substrate 1. Each of the color photoresists R, G and B corresponds to one sub-pixel, and the black matrix 2 separates any two adjacent sub-pixels to prevent light leakage. Generally, the material of the black matrix 2 is an insulating material, but it still has a certain conductivity, so that static electricity will be distributed along the black matrix 2 enters the color filter substrate from the edge of the base substrate 1 during manufacturing and operating of the color filter substrate, which led to abnormal display.

In order to solve the above technical problems, as shown in FIG. 1, a groove 3 is usually provided at a non-display area of the black matrix 2, the groove 3 blocks static electricity from being transmitted toward a display area in the color filter substrate. However, since the black matrix 2 is used to shield the light from light leakage, the light in a position corresponding to the groove 3 cannot be blocked after the groove 3 is provided, thereby resulting in the risk of light leakage at the edge of the liquid crystal display device.

### SUMMARY

In view of the deficiencies of the prior art, the present disclosure provides a liquid crystal display panel that avoids light leakage at the edge of the liquid crystal display panel while preventing static electricity from being transmitted along the black matrix toward the display area in the color filter substrate.

In order to achieve the above objectives, the present disclosure adopts the following technical solutions:

A liquid crystal display panel, comprises a TFT array substrate and a color filter substrate disposed opposite to each other, the color filter substrate has a black matrix disposed thereon, the black matrix comprises a first portion located in a display area and a second portion located in an non-display area, wherein the second portion of the black matrix is provided with a groove surrounding the display area, the groove penetrates the black matrix in a thickness direction of the black matrix, the TFT array substrate is provided with a light shielding layer corresponding to a location where the groove is disposed, and a projection of the light shielding layer on the black matrix completely covers the groove.

Herein, two color resist layers are further stacked on the second portion of the black matrix over an opening corresponding to the groove sequentially, the two color resisting material layers are selected from any two of red resist layer, green resist layer, and blue resist layer.

Herein, the two color resisting material layers are selected from red resist layer and blue resist layer.

Herein, the projection of the light shielding layer on the black matrix completely covers the two color resisting material layers.

Herein, a distance between an edge of the projection of the light shielding layer on the black matrix and an edge of the two color resisting material layers is 3 μm or more.

Herein, a distance between an edge of the projection of the light shielding layer on the black matrix and an edge of the two color resisting material layers is 3 μm.

Herein, a material of the light shielding layer is the same as a material of the black matrix.

Herein, a color photoresist layer is further disposed on the color filter substrate, the color photoresist layer comprises a red photoresist unit, a green photoresist unit and a blue photoresist, the first portion of the black matrix is provided with opening units distributed in array, and each of the red photoresist unit, the green photoresist unit and the blue photoresist unit is respectively disposed in a corresponding opening unit.

Another aspect of the present disclosure is to provide a liquid crystal display device, comprising a liquid crystal display panel and a backlight module. The liquid crystal display panel and the backlight module is disposed opposite to each other, the backlight module provides display light source to the liquid crystal display panel for displaying a display image of the liquid crystal display panel, and the liquid crystal panel adopts the foregoing described liquid crystal display panel.

According to the liquid crystal display panel provided by the present disclosure, a groove is provided on the black matrix of the color filter substrate at non-display area, through which the static electricity is prevented from being transmitted along the black matrix toward display area in the color filter substrate. At the same time, the light shielding layer completely covering the groove is arranged on the TFT array substrate to block the light emitted from the backlight from penetrating through the black matrix through the groove, so as to avoid light leakage at the edge of the liquid crystal display panel.

### BRIEF DESCRIPTION OF THE DRAWINGS

FIG. 1 is a structural schematic of a color filter substrate of prior art:

FIG. 2 is a structural schematic of a liquid crystal display panel according to one embodiment of the disclosure:

FIG. 3 is a structural schematic of a black matrix according to one embodiment of the disclosure;

FIG. 4 is a structural schematic of a liquid crystal display device according to one embodiment of the disclosure.

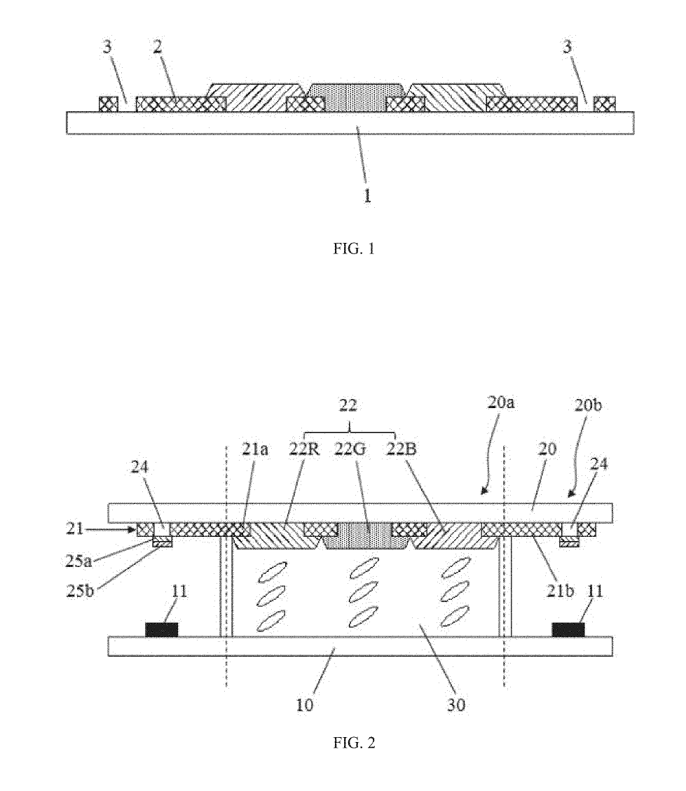

### DETAILED DESCRIPTION OF PREFERRED EMBODIMENTS

The disclosure will be further described in detail with reference to accompanying drawings and preferred embodiments as follows. It should be understood that the specific embodiments described herein are merely employed for explaining and understanding the present invention, but are not limitations thereto.

Herein, it should also be noted that in order to avoid obscuring the present disclosure by unnecessary details, only the structures and/or processing steps that are closely related to the solutions of the present disclosure are shown in the drawings, while omitting other details that are little relevance with the present disclosure.

As shown in FIG. 2, The embodiment provides a liquid crystal display panel, comprising a TFT array substrate 10 and a color filter substrate 20 disposed opposite to each other, a plurality of liquid crystals being disposed between the TFT array substrate 10 and the color filter substrate 20. Further, the TFT array substrate 10 comprises a pixel driving circuit of a thin film transistor, a data line, a scan line and pixel electrode. The color filter substrate 20 comprises a display area 20a and a non-display area surrounding the display area 20a, and a black matrix 21 and a color photoresist layer 22 are provided on the color filter substrate 20.

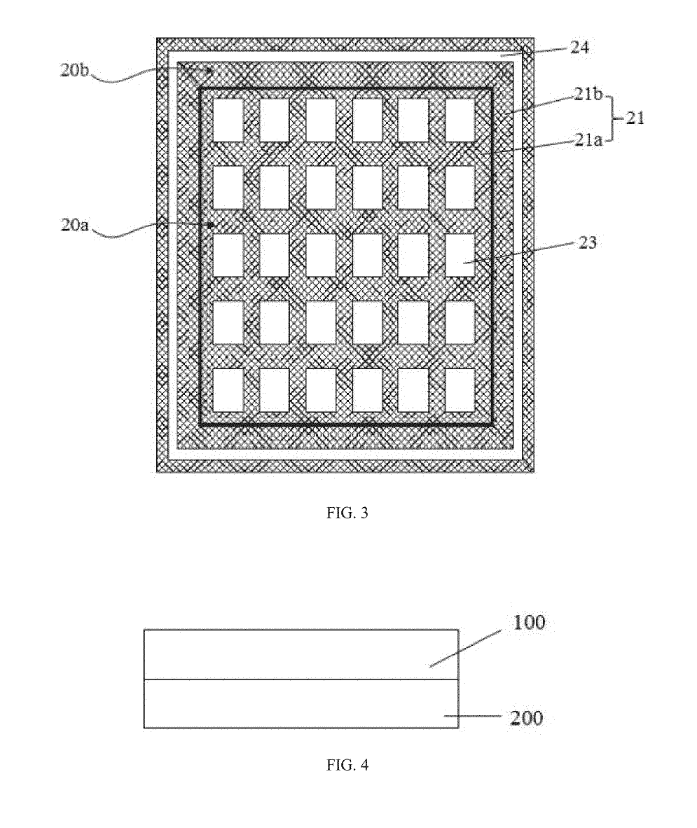

Please further refer to FIGS. 2 and 3, the black matrix 21 comprises a first portion 21a located in the display area 20a and a second portion 21b located in the non-display area 20b. The color photoresist layer 22 is disposed in the display area 20a, the color photoresist layer 22 comprises a red photoresist unit 22R, a green photoresist unit 22G, and a blue photoresist unit 22B. The first portion 21a of the black matrix 21 is provided with opening units 23 distributed in array, each of the red photoresist unit 22R, the green photoresist unit 22G and the blue photoresist unit 22B is respectively disposed in a corresponding opening unit 23. It should be noted that, in FIG. 2, only one red photoresist unit 22R, one green photoresist unit 22G and one blue photoresist unit 22B are exemplarily shown. Generally in a liquid crystal display panel, a red photoresist unit 22R corresponds to a red sub-pixel, a green photoresist unit 22G corresponds to a green sub-pixel, and a blue photoresist unit 22B corresponds to a blue sub-pixel. Each pixel unit includes one red sub-pixel, one green sub-pixel and one blue sub-pixel. In FIG. 3, only a few opening units 23 are shown by way of example.

Herein, please refer to FIGS. 2 and 3, the second portion 21b of the black matrix 21 is provided with a groove 24 surrounding the display area 20a, the groove 24 penetrates the black matrix 21 in a thickness direction of the black matrix 21. That is, the groove 24 divides the second portion 21b at the edge of the black matrix 21 into two completely separate part. Thus, the groove 24 is able to prevent the static electricity from being transmitted along the black matrix 21 toward the display area 20a in the color filter substrate 20 to prevent static electricity from adversely affecting the display image of the liquid crystal display panel.

Herein, as shown in FIG. 2, the TFT array substrate 10 is provided with a light shielding layer 11 corresponding to a location where the groove 24 is disposed, and a projection of the light shielding layer 11 on the black matrix 21 completely covers the groove 24. Since the black matrix 21 is provided with the groove 24, the groove 24 can no longer block light. In this case, the light shielding layer 11 can block the light emitted from the backlight reaches the groove 24, and avoids light leakage at the edge of the liquid crystal display panel. The material of the light shielding layer 11 can be selected to be the same as the material of the black matrix 21.

Furthermore, in the embodiment as shown in FIG. 2, two color resisting material layers 25a, 25b are further stacked on the second portion 21b of the black matrix 11 over an opening corresponding to the groove 24 sequentially. The two color resisting material layers 25a, 25b are selected from any two of red resisting material layer, green resisting material layer, and blue resisting material layer. By providing the two color resisting material layers 25a and 25b, it is equivalent to adding a filter layer in front of the groove 24. Generally, after the white light emitted from the backlight source, usually is two color resisting material layers as 25a, 25b, the light is completely filtered, so the position of the groove 24 is also free of light leakage. In this embodiment, by providing the light shielding layer 11 and the two color resisting material layers 25a and 25b, it is better to ensure that no light leakage will occur at the groove 24 position. In a preferred embodiment, the two color resisting material layers 25a, 25b are selected as the red resisting material layer and the blue resisting material layer.

Furthermore, in the embodiment, the projection of the light shielding layer 11 on the black matrix 21 completely covers the two color resisting material layers 25a, 25b. Specifically, a distance between an edge of the projection of the light shielding layer 11 on the black matrix 21 and an edge of the two color resisting material layers 25a, 25b is 3 μm.

In other embodiments, the distance between an edge of the projection of the light shielding layer 11 on the black matrix 21 and an edge of the two color resisting material layers 25a, 25b can be greater than 3 μm.

As shown in FIG. 4, the present disclosure further provides a liquid crystal display device. The liquid crystal display device comprises a liquid crystal display panel 100 and a backlight module 200, the liquid crystal display panel 100 and the backlight module 200 are disposed opposite to each other, the backlight module 200 provides display light source to the liquid crystal display panel 100 for displaying a display image of the liquid crystal display panel 100. Herein, the liquid crystal display device 100 adopts a liquid crystal display panel descried in the foregoing embodiment.

In summary, according to the liquid crystal display panel provided by the present disclosure, a groove is provided on the black matrix of the color filter substrate at non-display area, through which the static electricity is prevented from being transmitted along the black matrix toward display area in the color filter substrate. At the same time, the light shielding layer completely covering the groove is arranged on the TFT array substrate to block the light emitted from the backlight from penetrating through the black matrix through the groove, so as to avoid light leakage at the edge of the liquid crystal display panel.

It should be noted that, in this document, relational terms such as “the first” and “the second” are merely used to distinguish one entity or operation from another entity or operation, and do not necessarily require or imply that the entity or operation are in any actual relationship or order therebetween. Moreover, the terms “comprise”, “include.” or any other variations thereof are intended to cover a non-exclusive inclusion, such that a process, method, article, or device includes not only those elements but also other elements that are inherent to such process, method, article, or device. Without further limitations, an element limited by the statement “comprising a . . . ” does not exclude the existence of additional identical elements in the process, method, article, or device that includes the element.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A liquid crystal display panel, comprising a TFT array substrate and a color filter substrate disposed opposite to each other, the color filter substrate having a black matrix disposed thereon, the black matrix comprising a first portion located in a display area and a second portion located in an non-display area, wherein the second portion of the black matrix is provided with a groove surrounding the display area, the groove penetrates the black matrix in a thickness direction of the black matrix, the TFT array substrate is provided with a light shielding layer corresponding to a location where the groove is disposed, and a projection of the light shielding layer on the black matrix completely covers the groove.

2. The liquid crystal display panel according to claim 1, wherein two color resisting material layers are further stacked on the second portion of the black matrix over an opening corresponding to the groove sequentially, the two color resisting material layers are selected from any two of red resisting material layer, green resisting material layer, and blue resisting material layer.

3. The liquid crystal display panel according to claim 2, wherein the two color resisting material layers are selected from red resisting material layer and blue resisting material layer.

4. The liquid crystal display panel according to claim 2, wherein the projection of the light shielding layer on the black matrix completely covers the two color resisting material layers.

5. The liquid crystal display panel according to claim 4, wherein a distance between an edge of the projection of the light shielding layer on the black matrix and an edge of the two color resisting material layers is 3 μm or more.

6. The liquid crystal display panel according to claim 4, wherein a distance between an edge of the projection of the light shielding layer on the black matrix and an edge of the two color resisting material layers is 3 μm.

7. The liquid crystal display panel according to claim 1, wherein a material of the light shielding layer is the same as a material of the black matrix.

8. The liquid crystal display panel according to claim 1, wherein a color photoresist layer is further disposed on the color filter substrate, the color photoresist layer comprises a red photoresist unit, a green photoresist unit and a blue photoresist, the first portion of the black matrix is provided with opening units distributed in array, and each of the red photoresist unit, the green photoresist unit and the blue photoresist unit is respectively disposed in a corresponding opening unit.

9. A liquid crystal display device, comprising a liquid crystal display panel and a backlight module, the liquid crystal display panel and the backlight module being disposed opposite to each other, the backlight module providing display light source to the liquid crystal display panel for displaying a display image of the liquid crystal display panel, the liquid crystal panel comprising a TFT array substrate and a color filter substrate disposed opposite to each other, the color filter substrate having a black matrix disposed thereon, the black matrix comprising a first portion located in a display area and a second portion located in an non-display area, wherein the second portion of the black matrix is provided with a groove surrounding the display area, the groove penetrates the black matrix in a thickness direction of the black matrix, the TFT array substrate is provided with a light shielding layer corresponding to a location where the groove is disposed, and a projection of the light shielding layer on the black matrix completely covers the groove.

10. The liquid crystal display device according to claim 9, wherein two color resisting material layers are further stacked on the second portion of the black matrix over an opening corresponding to the groove sequentially, the two color resisting material layers are selected from any two of red resisting material layer, green resisting material layer, and blue resisting material layer.

11. The liquid crystal display device according to claim 10, wherein the two color resisting material layers are selected from red resisting material layer and blue resisting material layer.

12. The liquid crystal display device according to claim 10, wherein the projection of the light shielding layer on the black matrix completely covers the two color resisting material layers.

13. The liquid crystal display device according to claim 12, wherein a distance between an edge of the projection of the light shielding layer on the black matrix and an edge of the two color resisting material layers is 3 μm or more.

14. The liquid crystal display device according to claim 12, wherein a distance between an edge of the projection of the light shielding layer on the black matrix and an edge of the two color resisting material layers is 3 μm.

15. The liquid crystal display device according to claim 9, wherein a material of the light shielding layer is the same as a material of the black matrix.

16. The liquid crystal display device according to claim 9, wherein a color photoresist layer is further disposed on the color filter substrate, the color photoresist layer comprises a red photoresist unit, a green photoresist unit and a blue photoresist, the first portion of the black matrix is provided with opening units distributed in array, and each of the red photoresist unit, the green photoresist unit and the blue photoresist unit is respectively disposed in a corresponding opening unit.
